(19) United States
(12) Patent Application Publication
(10) Pub. No.: US 2014/0049447 A1
(43) Pub. Date: Feb. 20, 2014

(54) METHOD AND DEVICE FOR DISPLAYING IMAGE

(71) Applicant: Samsung Electronics Co., Ltd., Gyeonggi-do (KR)

(72) Inventor: Young-Keun Choi, Gyeonggi-do (KR)

(73) Assignee: Samsung Electronics Co., Ltd., Gyeonggi-do (KR)

(21) Appl. No.: 13/969,269

(22) Filed: Aug. 16, 2013

(30) Foreign Application Priority Data
Aug. 16, 2012 (KR) 10-2012-0089692

(51) Int. Cl. G06F 3/14

(52) U.S. Cl. CPC G06F 3/1423
USPC 345/1.2

(57) ABSTRACT

A method and an apparatus for displaying an image are provided. The image display method of the electronic device includes displaying an image, detecting at least one other electronic device, if the electronic device and the detected at least one other electronic device are located within a first threshold distance, transmitting the image and display control information to the at least one other electronic device to request for display of the image to the at least one other electronic device, and, if the electronic device and the detected at least one other electronic device are located within a second threshold distance, displaying the split image on the basis of the number of detected at least one other electronic device and the display control information.

### CROSS-REFERENCE TO RELATED APPLICATION(S) AND CLAIM OF PRIORITY

The present application is related to and claims priority under 35 U.S.C. §119(a) to a Korean Patent Application No. 10-2012-0089692 filed in the Korean Intellectual Property Office on Aug. 16, 2012, the contents of which are herein incorporated by reference.

### TECHNICAL FIELD

The present disclosure relates to an electronic device. More particularly, the present disclosure relates to a method and apparatus for displaying a shared image on electronic devices.

### BACKGROUND

In recent years, with a sudden growth of electronic devices such as a smart phone, a tablet Personal Computer (PC), etc., the electronic devices enabling wireless voice call and information exchange have become necessities of life. In the beginning of spreading, the electronic devices were recognized as portable devices simply enabling wireless call. With the development of technologies and the introduction of wireless Internet, the electronic devices are developing into multimedia devices performing functions of schedule management, game, remote control, image capturing, a projector, etc. to meet users' desires, beyond the portable devices simply enabling the wireless call.

Particularly, as the convenience and portability of electronic devices are becoming recently significant, miniaturized electronic devices are being launched. But, if a user executes an application by using the miniaturized electronic devices, he/she goes through an inconvenience in content use owing to small sizes of display devices. For instance, if the user executes an Internet application in a miniaturized smart phone, the miniaturized smart phone displays only some content of a web browser or zooms out contents within the web browser and displays the zoom-out content due to a small size of its touch screen. Because of this, to view other contents of the web browser, the user has to perform a control operation for dragging left/right a screen or zooming in contents within the web browser and displaying the zoom-in content. For another example, if the user executes a video application in the miniaturized smart phone, he/she can feel a difficulty in video viewing due to the small size of the touch screen. According to this, there is a need to provide a method capable of displaying an image larger even in a display device of a miniaturized electronic device.

### SUMMARY

To address the above-discussed deficiencies of the prior art, it is a primary object disclosure to provide a method and apparatus for sharing an image depending on a distance between electronic devices and displaying the image on a plurality of electronic devices.

Another aspect of the present disclosure is to provide a method and apparatus for splitting an image on an electronic device and sharing the image with other electronic device.

A further aspect of the present disclosure is to provide a method and apparatus for sharing a split image with other electronic device and displaying the image on an electronic device.

Yet another aspect of the present disclosure is to provide a method and apparatus for, when displaying an image on a plurality of electronic devices, outputting an audio signal according to a user's position.

Still another aspect of the present disclosure is to provide a method and apparatus for, when displaying a shared image on a plurality of electronic devices, determining a shared image display region on the basis of a display device size of each of the plurality of electronic devices.

Still another aspect of the present disclosure is to provide a method and apparatus for determining a shared image display region on the basis of a user input and displaying a shared image on the shared image display region on a plurality of non-aligned electronic devices.

Still another aspect of the present disclosure is to provide a method and apparatus for, when displaying a shared image on a plurality of electronic devices with display devices of different sizes, performing an additional function by using a region other than a shared image display region.

The above aspects are achieved by providing a method for displaying an image and an electronic device thereof.

According to one aspect of the present disclosure, an image display method of an electronic device is provided. The method includes displaying an image, detecting at least one other electronic device, if the electronic device and the detected at least one other electronic device are located within a first threshold distance, transmitting the image and display control information to the at least one other electronic device to display the image on the at least one other electronic device, and, if the electronic device and the detected at least one other electronic device are located within a second threshold distance, transmitting the image and display control information to the at least one other electronic device to display the split image by the number of detected at least one other electronic device and the display control information.

According to another aspect of the present disclosure, an image display method of an electronic device is provided. The method includes detecting at least one other electronic device, if the electronic device and the detected at least one other electronic device are located within a first threshold distance, receiving an image and display control information from the detected at least one other electronic device, displaying the received image, and, if the electronic device and the detected at least one other electronic device are located within a second threshold distance, transmitting the image and display control information to the at least one other electronic device to display the split image on the basis of the display control information. The display control information includes information on at least one of a region to be displayed in each electronic device among the whole region of an original image, zoom-in, and a region to display an image among the whole region of a display device of each electronic device.

According to a further aspect of the present disclosure, an image display electronic device is provided. The device includes one or more processors, a display device for presentation of information, a communication device for communication, a memory for storing data and instructions, and one or more programs. The one or more programs are stored in the memory and are configured to be executed by the one or more processors. The program includes an instruction set for displaying an image, detecting at least one other electronic device and, if the electronic device and the detected at least one other electronic device are located within a first threshold distance, transmitting the image and display control information to the at least one other electronic device to request for display of the image to the at least one other electronic device and, if the electronic device and the detected at least one other electronic device are located within a second threshold distance, displaying the split image on the basis of the number of detected at least one other electronic device and the display control information.

According to a yet another aspect of the present disclosure, an image display electronic device is provided. The device includes one or more processors, a display device for presentation of information, a communication device for communication, a memory for storing data and instructions, and one or more programs. The one or more programs are stored in the memory and are configured to be executed by the one or more processors. The program includes an instruction set for detecting at least one other electronic device and, if the electronic device and the detected at least one other electronic device are located within a first threshold distance, receiving an image and display control information from the detected at least one other electronic device, displaying the received image and, if the electronic device and the detected at least one other electronic device are located within a second threshold distance, receiving an image and display control information to display the split image on the basis of the display control information. The display control information includes information on at least one of a region to be displayed in each electronic device among the whole region of an original image, zoom-in, and a region to display an image among the whole region of a display device of each electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a block diagram illustrating a construction of an electronic device for sharing and displaying an image according to an embodiment of the present disclosure;

FIG. 1B is a block diagram illustrating a processor of an electronic device for sharing and displaying an image according to an embodiment of the present disclosure;

FIG. 2A is a diagram illustrating an example of splitting an image into two images with the same size, and zooming in the two images on an electronic device according to an embodiment of the present disclosure;

FIG. 2B is a diagram illustrating an example of splitting an image into three images having the same size and zooming in the three images in an electronic device according to an embodiment of the present disclosure;

FIG. 2C is a diagram illustrating an example of splitting an image into three images having different sizes and zooming in the three images in an electronic device according to an embodiment of the present disclosure;

FIG. 3A is a flowchart illustrating a procedure for displaying an image according to a distance on an electronic device according to an embodiment of the present disclosure;

FIG. 3B is a diagram illustrating a means for displaying an image on an electronic device according to an embodiment of the present disclosure;

FIG. 4A is a flowchart illustrating a procedure of sharing an image with other electronic devices with a display device of the same size and displaying the shared image on an electronic device according to an embodiment of the present disclosure;

FIG. 4B is a flowchart illustrating a procedure of sharing an image with other electronic devices with a display device of a different size and displaying the shared image on an electronic device according to another embodiment of the present disclosure;

FIGS. 4C and 4D are diagrams illustrating examples of displaying a shared image on two electronic devices with display devices of different sizes according to another embodiment of the present disclosure;

FIG. 5 is a diagram illustrating an example of displaying an image when a distance to detect other electronic devices is greater than a first threshold distance in an electronic device according to a further embodiment of the present disclosure;

FIG. 6 is a diagram illustrating an example of displaying a shared image when a distance to detect other electronic devices is equal to or is less than a first threshold distance in an electronic device according to a further embodiment of the present disclosure;

FIG. 7 is a diagram illustrating an example of displaying a shared image when a distance to detect other electronic devices is equal to or is less than a second threshold distance in an electronic device according to a further embodiment of the present disclosure;

FIG. 8 is a flowchart illustrating a procedure of receiving a shared image from detected other electronic devices and displaying the shared image on an electronic device according to a further embodiment of the present disclosure;

FIG. 9 is a flowchart illustrating a procedure of outputting an audio signal toward a user's position in an electronic device according to a further embodiment of the present disclosure;

FIGS. 10A and 10B are diagrams illustrating examples of outputting an audio signal in a plurality of electronic devices displaying a shared image according to a further embodiment of the present disclosure;

FIGS. 11A to 11D are diagrams illustrating examples of transmitting an image including a video User Interface (UI) to detect other electronic devices and displaying the image on an electronic device according to a further embodiment of the present disclosure;

FIGS. 12A to 12C are diagrams illustrating examples of sharing an Internet image depending on a distance between electronic devices and displaying the Internet image on a plurality of the electronic devices according to a further embodiment of the present disclosure; and

FIGS. 13A and 13B are diagrams illustrating examples of determining a shared image display region in a plurality of non-aligned electronic devices according to a further embodiment of the present disclosure.

### DETAILED DESCRIPTION OF THE DISCLOSURE

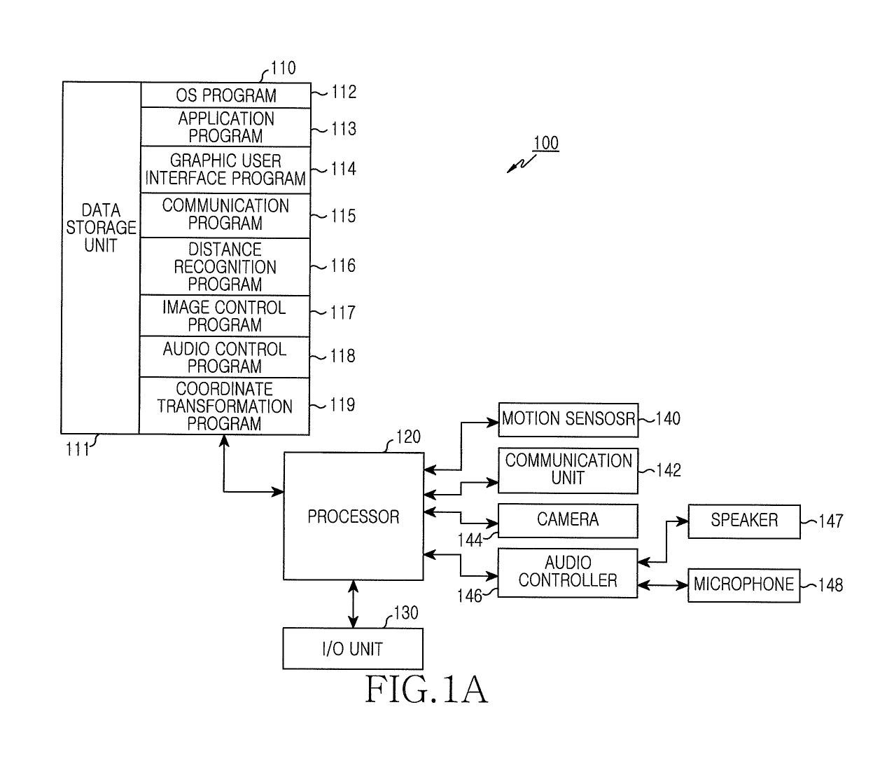

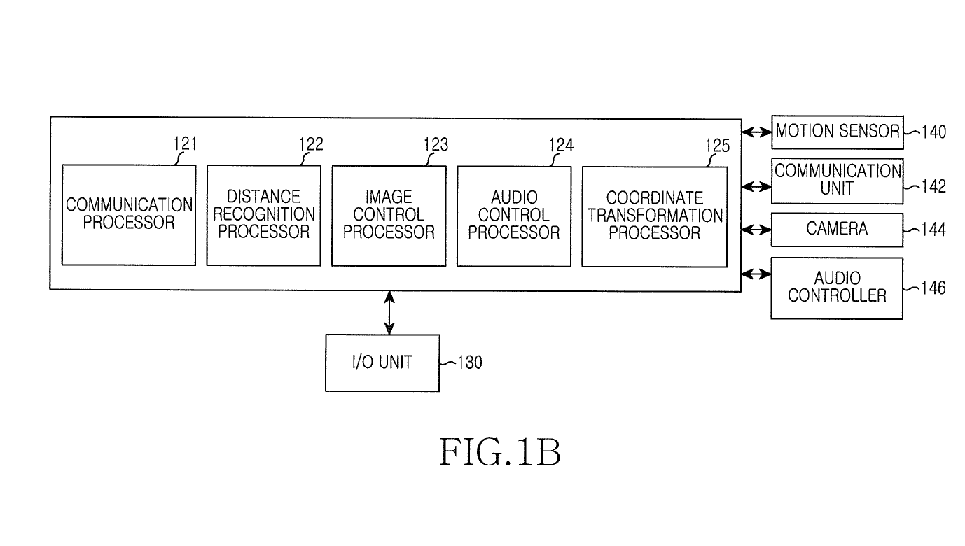

FIGS. 1A through 13B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be different depending on user and operator's intention or practice. Therefore, the terms should be defined on the basis of the disclosure throughout this specification.

In the following description, an electronic device can be a mobile communication terminal with a display device, a smart phone, a tablet Personal Computer (PC), an MPEG Audio Layer-3 (MP3) player, a laptop computer, a netbook computer, a computer, a television and the like.

FIG. 1A is a block diagram illustrating a construction of an electronic device 100 for sharing and displaying an image according to an embodiment of the present disclosure.

Referring to FIG. 1A, the electronic device 100 includes a memory 110, a processor 120, an Input Output (IO) unit 130, a motion sensor 1140, a communication unit 142, a camera 144, an audio controller 146, a speaker 147, and a microphone 148. The memory 110 and the processor 120 can be composed of a plurality of memories 110 and a plurality of processors 120, respectively.

The memory 110 includes a data storage unit 111, an Operating System (OS) program 112, an application program 113, a graphic User Interface (UI) program 114, a communication program 115, a distance measurement program 116, a display control program 117, an audio control program 118, a coordinate transformation program 119 and the like. Also, a soft program can be expressed as a set of instructions and therefore, the software program is also referred to as an instruction set as well as a module.

The memory 110 can store one or more programs that include instructions performing an embodiment of the present disclosure.

The data storage unit 111 stores data generated during the execution of a function corresponding to a program stored in the memory 110. The data storage unit 111 according to the present disclosure can store model information of the electronic device 100. At this time, the model information of the electronic device 100 can include display device size information of the electronic device 100 and resolution information thereof. The display device size information indicates size information of a region capable of displaying an image on the electronic device 100. Also, the data storage unit 111 can store a threshold distance for a distance between the electronic device 100 and at least one other electronic device that is detected by the communication program 115. That is, the data storage unit 111 can store a first threshold distance and a second threshold distance. At this time, the first threshold distance is stored as a value greater than the second threshold distance. Here, the first threshold distance represents a distance for allowing the electronic device 100 and at least one other electronic device to convert into a sharing mode and operate in the sharing mode, and the second threshold distance represents a distance for allowing the electronic device 100 and at least one other electronic device to convert into a split mode and operate in the split mode. Here, the sharing mode indicates a mode in which the electronic device 100 and at least one other electronic device display the same portion of the same image, and the split mode indicates a mode in which the electronic device and at least one other electronic device display different portions of the same image. Further, the data storage unit 111 can store a sound filter by predetermined user position. Here, the sound filter by user position can be previously acquired according to experiments, or can be updated through learning of the electronic device 100.

The OS program 112 (for example, a built-in operating system such as WINDOWS, LINUX, Darwin, RTXC, UNIX, OS X, and VxWorks) includes various software constituent elements controlling a general system operation. For instance, the control of the general system operation means memory management and control, storage hardware (device) control and management, power control and management and the like. The OS program 112 performs a function of making smooth communication between various hardware (device) and software constituent element (program).

The application program 113 includes applications of a browser, an electronic mail (e-mail), a message, word processing, an address book, a widget, Digital Right Management (DRM), voice recognition, voice replication, a position determining function, a location-based service, a video, music and the like.

The graphic user interface program 114 includes at least one software constituent element for providing a user interface using a graphic between a user and the electronic device 100. That is, the graphic user interface program 114 includes at least one software constituent element for displaying user interface information on a display device (e.g., a touch screen) included in the Input/Output (I/O) unit 130. According to the present disclosure, the graphic user interface program 114 includes an instruction for displaying an image and a related User Interface (UI) on the I/O unit 130. For example, the graphic user interface program 114 can include an instruction for displaying a video application on the I/O unit 130, and include an instruction for visually displaying a related UI for the displayed video application. For another example, the graphic user interface program 114 can include an instruction for splitting and visually displaying a video image and a related UI for a video application on the I/O unit 130.

The communication program 115 enables communication with other electronic devices such as a server and/or a portable terminal, etc. through the communication unit 142. The communication program 115 transmits/receives information required for the electronic device 100 and other electronic devices to display a shared image. That is, the communication program 115 transmits/receives at least one of model information, size information of a display device, resolution information, an image, split information, a user voice signal reception time, and an audio signal with detected other electronic device.

The distance measurement program 116 can determine a distance to at least one other electronic device detected by the motion sensor 140 and the communication unit 142. If the distance to the detected at least one other electronic device is equal to or is less than the first threshold distance stored in the data storage unit 111, the distance measurement program 116 determines an operation for the sharing mode and, if the distance is equal to or is less than the second threshold distance, the distance measurement program 116 determines an operation for the split mode.

Also, the distance measurement program 116 can analyze an image captured by the camera 144 of the electronic device 100 and determine a distance between the electronic device 100 and a user. In detail, the distance measurement program 116 can analyze the image captured by the camera 144 of the electronic device 100 and measure a distance and position of each user included within the captured image. At this time, the distance measurement program 116 can determine a position of each user by using not only the image captured by the camera 144 of the electronic device 100 but also an image captured by a camera 144 of the detected at least one electronic device. Further, the distance measurement program 116 can determine a position of a user by analyzing a difference between a time at which a audio signal is received through the microphone 148 of the electronic device 100 and a time at which a audio signal of the detected at least one other electronic device is received through the communication unit 142. At this time, the distance measurement program 116 analyzes reception time of a plurality of audio signals received by the microphone 148 and reception time of a plurality of audio signals received through the communication unit 142 for each user and then, can determine a position by user based on the audio signals analyzed for each user and the distance between the electronic device 100 and the detected at least one other electronic device.

The display control program 117 can recognize as an image a screen displayed by the I/O unit 130 and control the image. In other words, the display control program 117 can control a function for sharing with other electronic device an image to be displayed on a display device (not shown) of the I/O unit 130 according to the execution of an application. For example, the display control program 117 can control a function for sharing with other electronic device a video image to be displayed on the display device (not shown) of the I/O unit 130 according to the execution of a video application. For further example, the display control program 117 can control a function for sharing with other electronic device a web browser image to be displayed on the display device (not shown) of the I/O unit 130 according to the execution of an Internet application.

If the electronic device 100 is in the sharing mode, the display control program 117 receives model information of detected other electronic device, resolution information thereof, number information thereof, and location information thereof from the motion sensor 140 and the communication unit 142 and on the basis of the received information, the display control program 117 generates split information for a shared image. Here, the location information means information representing in which direction of the electronic device 100 the detected other electronic device is located. Also, the split information is information required for the electronic device 100 and the detected at least one other electronic device to operate in the split mode and display different portions of the same image. The split information can include information about a region to be displayed in each electronic device among the whole region of an original image, zoom-in information by mode, and information about a region to display an image among the whole region of a display device of each electronic device. The display control program 117 can include an instruction for transmitting an image that is being displayed by the I/O unit 130 or an image stored in a buffer to be displayed and generated split information, to the detected other electronic device. Also, the display control program 117 can include an instruction for real-timely transmitting an image to be updated and displayed according to an application that is being executed or a user control, to the detected other electronic device. Here, the image transmitted to the detected other electronic device includes a graphic element representing a UI of an application which is being executed in the electronic device 100. For example, the display control program 117 can include an instruction for, when the electronic device 100 is executing a video application, transmitting not merely a video image but also an image including a UI (e.g., a pause icon, a play icon, and a stop icon and the like) of the video application to the detected other electronic device.

Also, if the electronic device 100 is in the split mode, the display control program 117 can split an original image to be displayed into a plurality of partial images on the basis of split information previously generated in the sharing mode and then, distinguish the plurality of split images into an image to be displayed in the electronic device 100 and an image to be displayed in the other electronic device, display the image to be displayed in the electronic device 100, and transmit the image to be displayed in other electronic device to the other electronic device. Also, if the electronic device 100 is in the split mode, the display control program 117 can determine a region of an image to be displayed in the electronic device 100 among the whole region of an original image to be displayed on the basis of the split information previously generated in the sharing mode, display only the determined region, and transmit the original image to be displayed to the other electronic device. At this time, the other electronic device can split the received original image into a plurality of partial images according to the split information and then display only a corresponding image among the plurality of split images, or the other electronic device can determine a corresponding image region in the received original image according to the split information and then display only the corresponding image region.

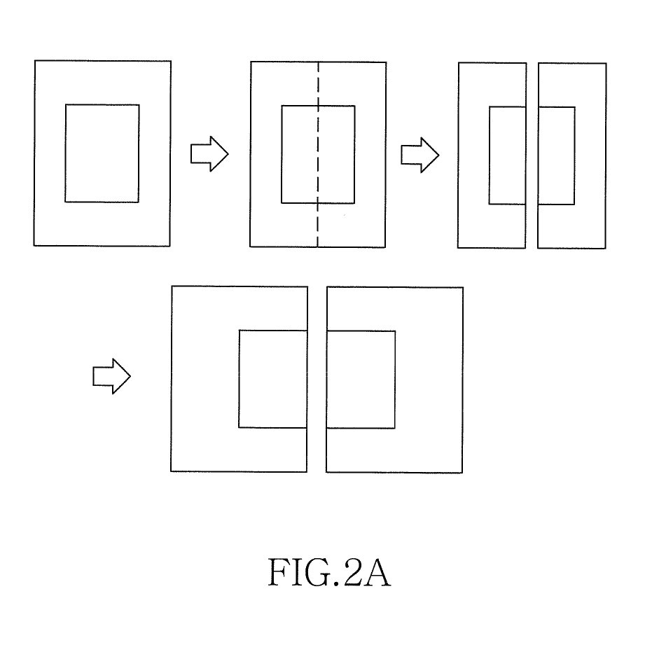

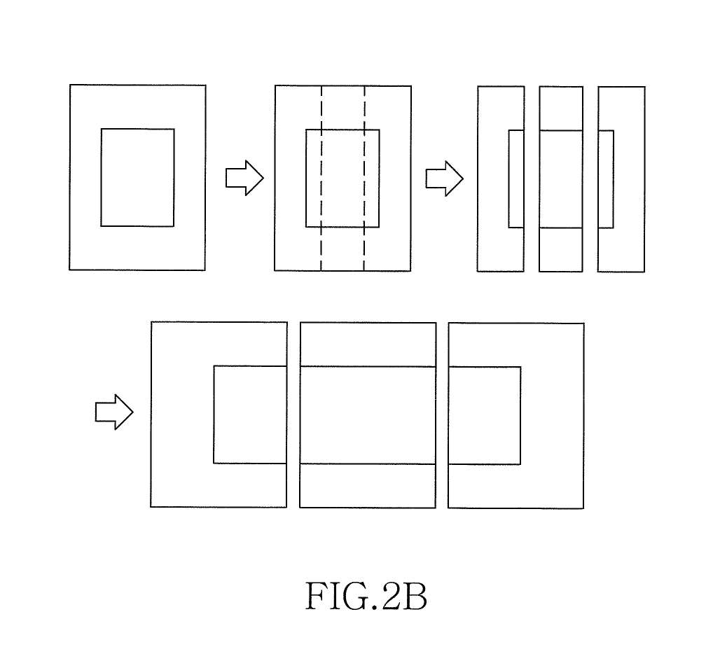

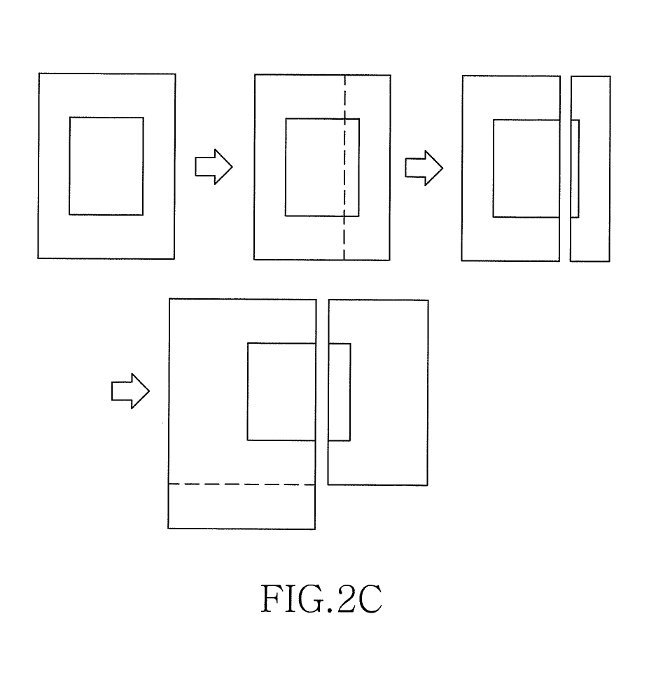

Also, the display control program 117 can generate image split information according to a display device size of the electronic device 100 and a display device size of the detected electronic device. That is, if at least one other electronic device with a display device of the same size as the display device size of the electronic device 100 is detected, the display control program 117 can generate split information for splitting an image by the number of detected other electronic devices, with the same size. For example, if one electronic device with a display device of the same size as the display device size of the electronic device 100 is detected, as illustrated in FIG. 2A, the display control program 117 can generate split information for splitting an image into two images having the same size and zooming in each of the split two images as much as the display device size of the electronic device 100. For another example, if two electronic devices with display devices of the same size as the display device size of the electronic device 100, as illustrated in FIG. 2B, the display control program 117 can generate split information for splitting an image into three images having the same size and then, zooming in the split three images as much as the display device size of the electronic device 100.

Alternatively, if other electronic device with a display device of a size different from the display device size of the electronic device 100 is detected, the display control program 117 can generate split information for splitting an original image into a plurality of the split images having different sizes corresponding to display device sizes of the electronic device 100 and the other electronic device. For example, if one electronic device with a display device of a size smaller than the display device size of the electronic device 100 is detected, as illustrated in FIG. 2C, the display control program 117 can generate split information for splitting an original image into two images corresponding to display device sizes of the electronic device 100 and the detected other electronic device, and zooming in each of the split two images as much as each of the display device sizes of the electronic devices. At this time, the display control program 117 can change a resolution of an image to be displayed, depending on the number of detected other electronic devices and an array of the electronic device 100 and the detected other electronic devices.

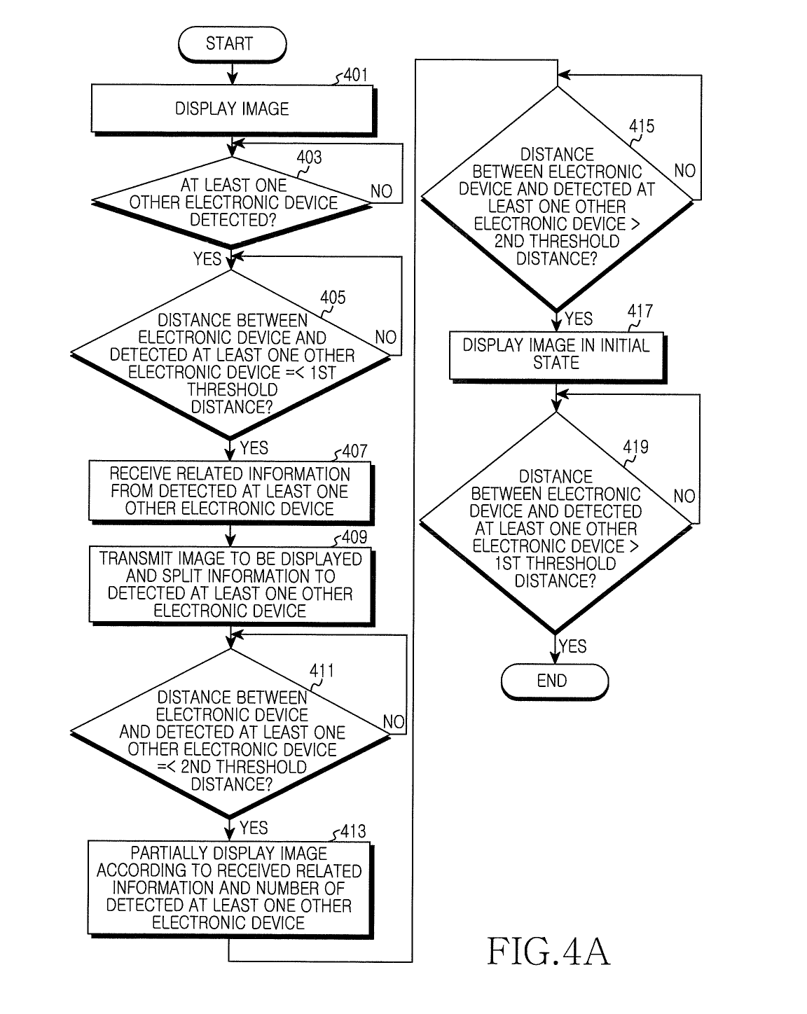

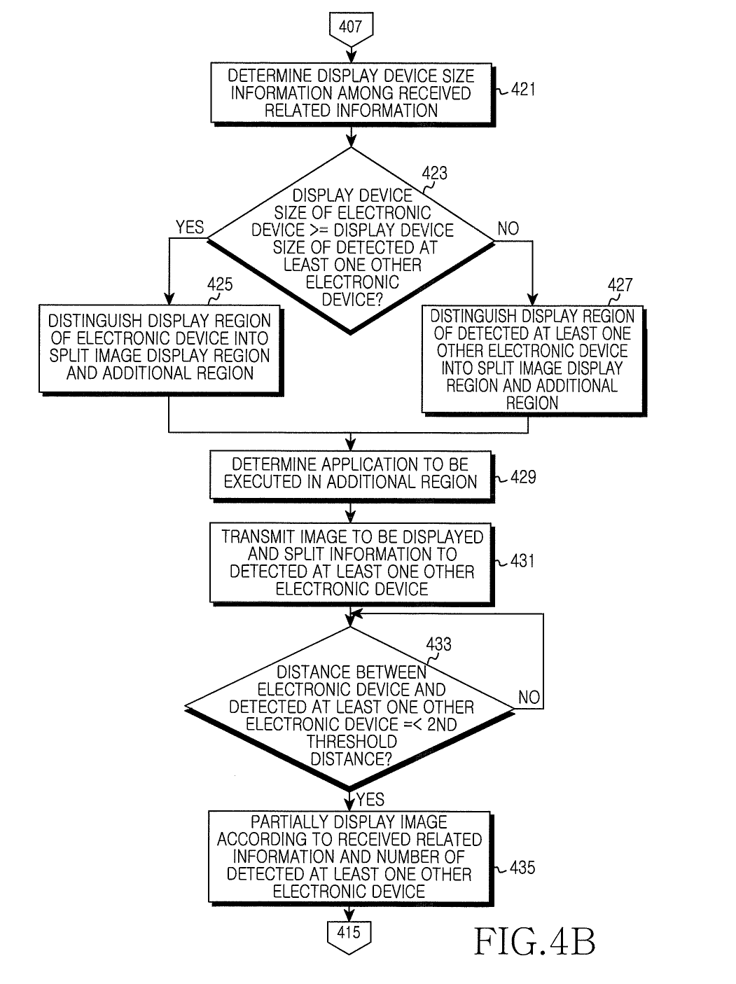

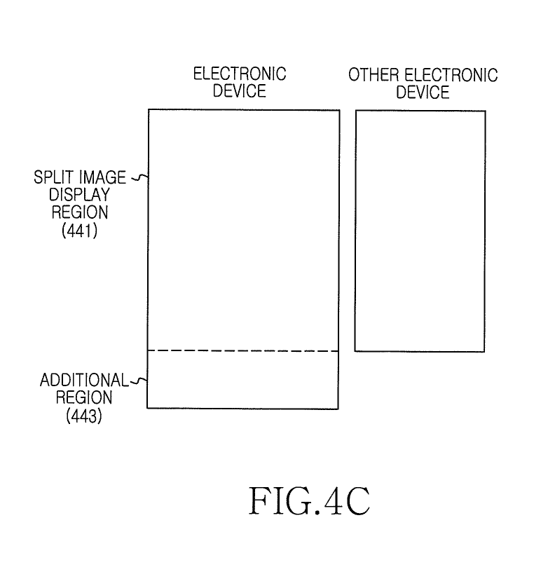

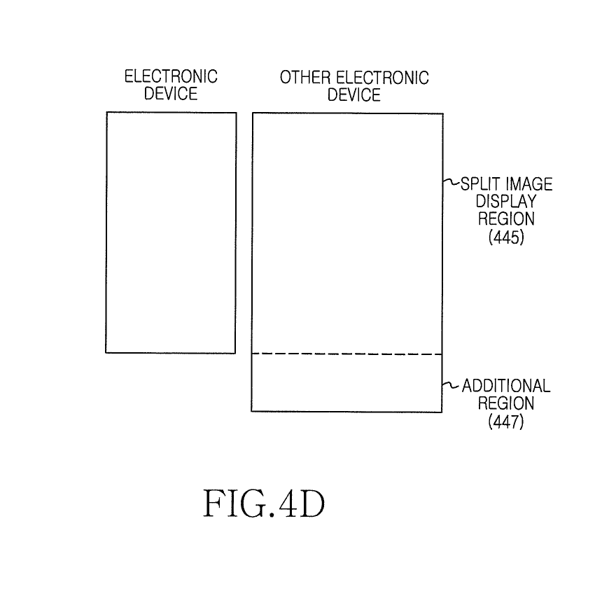

Also, the display control program 117 determines a region to display an image among the whole region of a display device of each electronic device on the basis of a display device size of the electronic device 100 and a display device size of detected other electronic device, and includes information about the image display region of the display device, in split information. For example, as illustrated in FIG. 4C, if the display device size of the electronic device 100 is larger than the display device size of the detected other electronic device, the display control program 117 can distinguish the whole region of the display device of the electronic device 100 into a split image display region and an additional region by considering the display device size of the detected other electronic device. For another example, as illustrated in FIG. 4D, if the display device size of the electronic device 100 is smaller than the display device size of the detected other electronic device, the display control program 117 can distinguish the whole region of the display device of the detected other electronic device into a split image display region and an additional region on the basis of the display device size of the electronic device 100. At this time, the display control program 117 includes an instruction for displaying an image showing the execution of other application in the additional region. For example, the display control program 117 includes an instruction for displaying information about a shared image in the additional region during shared image display, or displaying an image for an application whose additional execution is requested according to a user request.

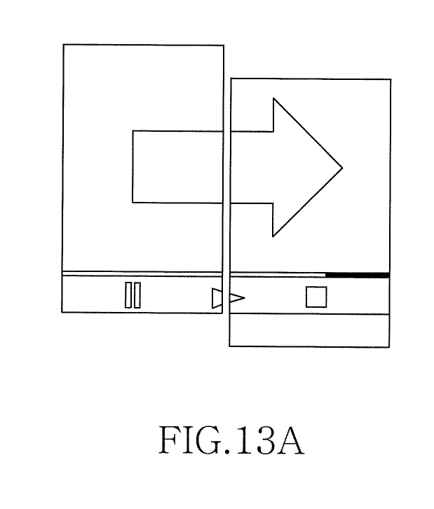

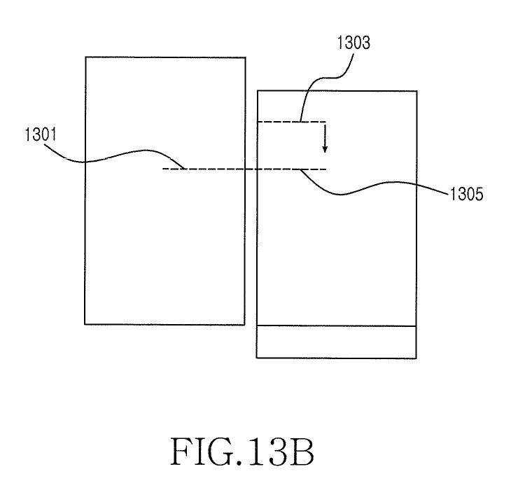

Further, the display control program 117 controls a function for, when the electronic device 100 and detected other electronic device are not aligned in line, synchronizing shared images displayed in the two electronic devices. For instance, the display control program 117 controls a function for, when the two electronic devices are not aligned in line as illustrated in FIG. 13A, presenting guide lines 1301 and 1303 for aligning shared images displayed in the two electronic devices, recognizing a user control for the guide lines 1301 and 1303, and determining a region to display an image among the whole region of a display device of each electronic device and a region to be displayed in each electronic device among the whole region of an original image, thereby displaying the shared images by aligning the shared images in line as illustrated in FIG. 13B. Here, to synchronize the shared images with each other, the display control program 117 can use user inputs of various schemes. For example, the display control program 117 can request for a user to do a line touch for a plurality of electronic devices, analyze a coordinate corresponding to the line touch, and determine a region to display an image among the whole region of a display device of each electronic device and a region to be displayed in each electronic device among the whole region of an original image, thereby displaying the shared images by aligning the shared images in line in the plurality of electronic devices.

Also, the display control program 117 can receive an image of other electronic device detected through the motion sensor 140 and the communication unit 142 and split information thereof from the detected other electronic device, and display the received image. If the electronic device 100 is in the sharing mode, the display control program 117 controls to display an image, which is real-timely received from the detected other electronic device on a display device (not shown) of the electronic device 100. At this time, if a display device size of the electronic device 100 is different from that of the detected other electronic device, instead of splitting the received image, the display control program 117 can zoom in the received image according to zoom-in information included in the split information and display the zoom-in image. According to this, the electronic device 100 being in the sharing mode can display the same image as the detected other electronic device.

If the electronic device 100 is in the splitting mode, the display control program 117 can either real-timely receive a split image from detected other electronic device and display the received image or can real-timely receive an original image from the detected other electronic device, split the original image on the basis of split information, and display a split image of a predetermined region among the whole region of the original image. That is, if a split image including only a region to be displayed in the electronic device 100 among the whole region of the original image is received from the detected other electronic device, the display control program 117 can zoom in or maintain the received split image according to zoom-in information among the split information and display the image on a display device of the electronic device 100. Alternatively, if an image including the whole region of the original image is received from the detected other electronic device, the display control program 117 determines a region to be displayed in the electronic device 100 among the whole region of the original image according to the split information. Next, after cutting the determined region from the original image, the display control program 117 can either zoom in or maintain an image of the cut region according to zoom-in information and display the image of the cut region in the display device of the electronic device 100 or can zoom in or maintain the original image according to the zoom-in information and display only the determined region in the display device of the electronic device 100.

If the electronic device 100 is in the sharing mode or the split mode, the audio control program 118 controls an audio signal to be outputted to the speaker 148, based on the number of other electronic devices detected by the motion sensor 140 and the communication unit 142, the number of users determined by the distance measurement program 116, and a position by user. In other words, to provide a stereoscopic sound and surround system, the audio control program 118 can control the audio controller 146 to divide an audio channel based on the number of detected other electronic devices, generate a sound filter designed optimally based on the number of users and the position by user, and output an audio signal through the generated filter. At this time, the sound filter can be generated using the known various techniques such as a Head Room Transfer Filter (HRTF) and the like. At this time, the audio control program 118 can either generate a sound filter having directivity based on the number of users and the position by user, or read out a sound filter previously determined according to a user position from the data storage unit 111 and apply the read sound filter. Also, the audio control program 118 includes an instruction for transmitting information about the generated sound filter to detected other electronic device.

If coordinate information of an image onto which data is inputted is received from detected other electronic device, the coordinate transformation program 119 controls to execute a function corresponding to a received image coordinate, and transmits the execution result to the detected other electronic device through the communication unit 142. Also, when an image received from the detected other electronic device is being displayed, if a user touch on the image is sensed, the coordinate transformation program 119 transmits a coordinate of the touch-sensed image to the detected other electronic device through the communication unit 142. As a result, the coordinate transformation program 119 enables the electronic device 100 and the detected other electronic device to display the same result according to the data inputted in the detected other electronic device.

Although not illustrated, the processor 120 can be composed of at least one processor and a peripheral interface. Also, the processor 120 executes a specific program (i.e., instruction set) stored in the memory 110 and performs a plurality of specific functions corresponding to the executed program.

The I/O unit 130 includes an input device receiving data input and an output device transmitting data output, and provides an interface to a user. For example, the I/O unit 130 can be a touch screen in which data input and output are concurrently possible. The I/O unit 130 according to the present disclosure can receive an input of image data, and can display a corresponding image received.

The motion sensor 140 can detect a motion of an object and a location thereof. The motion sensor 140 according to the present disclosure can detect other devices at least one other electronic device in the peripheral. Further, the motion sensor 140 can determine the number of detected other electronic devices and locations thereof. For example, the motion sensor 140 can determine that one detected other electronic device is located at the left side of the electronic device 100, and one detected other electronic device is located at the right side thereof.

The communication unit 142 can include a Radio Frequency (RF) receiver and transceiver and/or an optical (e.g., infrared) receiver and transceiver. For example, the communication unit 142 can include a wireless communication system that supports any one of a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (WiFi) network, a Near Field Communication (NFC) network, an Infrared Data Association (IrDA) network, a Wireless interoperability for Microwave Access (WiMAX) network, or/and a Bluetooth network. A wireless communication system according to the present disclosure is not limited to the wireless communication system supporting the aforementioned networks but can be a wireless communication system supporting other networks. The communication unit 142 according to the present disclosure can detect at least one other electronic device, and can communicate with the detected at least one other electronic device. The communication unit 142 can measure a distance between the electronic device 100 and the detected at least one other electronic device through signal transmission/reception with the detected at least one other electronic device. Also, the communication unit 142 transceives at least one of model information, display device size information, resolution information, an image, split information, a user voice signal reception time, an audio signal, and a coordinate at which a user input is sensed, with the detected at least one other electronic device.

The audio controller 146 is coupled to the speaker 147 and the microphone 148, and performs a function of audio stream input and output such as voice recognition, voice replication, digital recording and telephony functions. That is, the audio controller 146 performs a function for assigning directivity to an audio signal by using a sound filter generated by the audio control program 118, outputting the audio signal through the speaker 147, and receiving an input of a user's voice signal through the microphone 148. The audio controller 146 receives a data stream through the processor 120, converts the received data stream into an electric stream (i.e., electric signal), and forwards the converted electric stream to the speaker 147. The audio controller 146 receives a converted electric stream from the microphone 148, converts the received electric stream into an audio data stream, and transmits the converted audio data stream to the processor 120. The audio controller 146 can include a detachable earphone, headphone or head set. The speaker 147 converts the electric stream received from the audio controller 146 into human-audible sound waves and outputs the sound waves. The microphone 148 converts sound waves forwarded from human or other sound sources, into electric streams.

FIG. 1B illustrates a processor of an electronic device 100 for sharing and displaying an image according to an embodiment of the present disclosure.

As illustrated in FIG. 1B, the processor 120 of the electronic device 100 includes a communication processor 121, a distance measurement processor 122, an image control processor 123, an audio control processor 124, and a coordinate transformation processor 125. The processor 120 of the electronic device 100 can perform the functions described in FIG. 1A by controlling operations of the memory 110, the I/O unit 130, the motion sensor 140, the communication unit 142, the camera 144, the audio controller 146, the speaker 147, and the microphone 148.

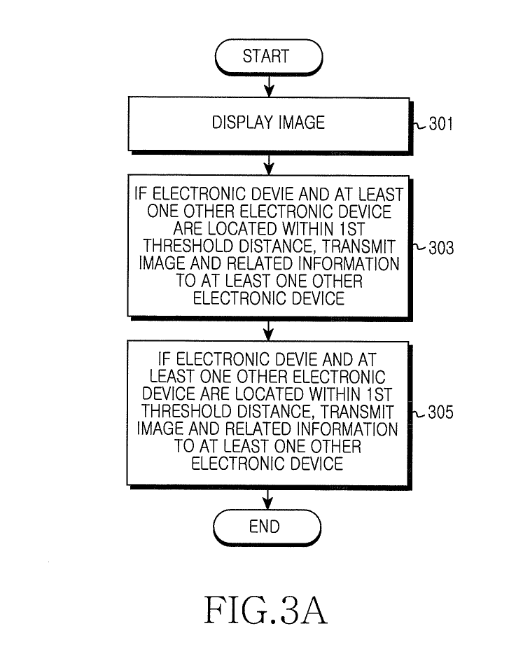

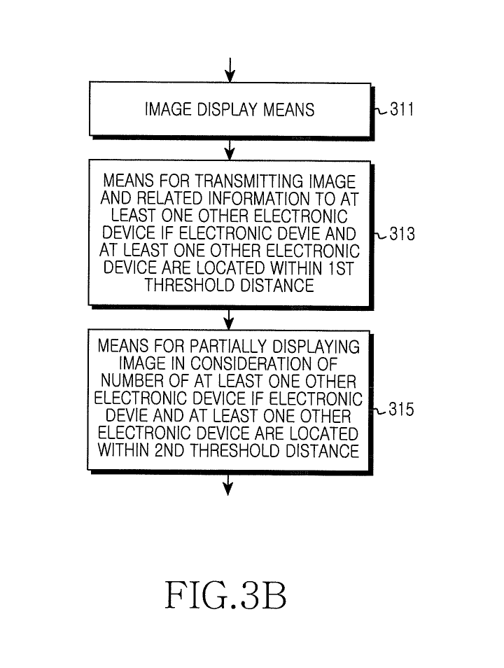

FIG. 3A illustrates a procedure for displaying an image based on a distance in an electronic device 100 according to an embodiment of the present disclosure.

Referring to FIG. 3A, in step 301, the electronic device 100 displays an image. Here, the image refers to an image including all graphic elements (e.g., an icon, a UI, an image and the like) displayed in a display device of the electronic device 100.

Next, the electronic device 100 proceeds to step 303 and, if the electronic device 100 and at least one other electronic device are located within a first distance, transmits the image and related information to the at least one other electronic device. In detail, the electronic device 100 detects peripheral at least one other electronic device and, if the detected other electronic device is located within the first threshold distance, real-timely transmits an image to be displayed in the electronic device 100 and information necessary for displaying an image on the detected other electronic device. For instance, when the electronic device 100 is playing and displaying a video, the electronic device 100 can either transmit the video to the detected other electronic device located within the first threshold distance or can real-timely transmit an image to be displayed at video playing to the detected other electronic device located within the first threshold distance. Here, the related information includes one of model information of the electronic device 100, size information of a display device of the electronic device 100, and resolution information of the display device of the electronic device 100.

Next, the electronic device 100 proceeds to step 305 and if the electronic device 100 and the at least one other electronic device are located within a second threshold distance, displays the split image by the number of at least one other electronic device. For example, if one other electronic device located within the second threshold distance is detected, the electronic device 100 can split an image to two images and then display one of the split two images.

FIG. 3B illustrates a means for displaying an image in an electronic device 100 according to an embodiment of the present disclosure.

Referring to FIG. 3B, the electronic device 100 includes a means 311 displaying an image. Here, the image refers to an image including all graphic elements (e.g., an icon, a UI, an image and the like) displayed in a display device of the electronic device 100. Also, the electronic device 100 includes a means 313 for, if the electronic device 100 and at least one other electronic device are located within a first threshold distance, transmitting the image and related information to the at least one other electronic device. Whether the at least one other electronic device is located within the first threshold distance can be determined through the motion sensor 140 and the communication unit 142. Further, the electronic device 100 includes a means 315 for, if the electronic device 100 and the at least one other electronic device are located within the second threshold distance, displaying the part of the image on the basis of the number of at least one other electronic device. Here, the partially displayed image can be a zoomed image in comparison to the first split image.

FIG. 4A illustrates a procedure of sharing an image with other electronic device with a display device of the same size and displaying the shared image in an electronic device according to an embodiment of the present disclosure.

Referring to FIG. 4A, in step 401, the electronic device 100 displays an image. Here, the image refers to an image including all graphic elements (e.g., an icon, a UI, an image and the like) displayed in a display device of the electronic device 100. Also, the image can be an image according to the execution of contents previously stored in the electronic device 100, or can be an image acquired from a server or other electronic device.

Next, in step 403, the electronic device 100 determines if at least one other electronic device is detected. At this time, the electronic device 100 can detect the at least one other electronic device through at least one of a plurality of sensors such as NFC, a motion sensor, IrDA and the like and wireless communication, and can determine a distance to the detected at least one other electronic device and the direction or location of the detected at least one other electronic device.

If it is determined in step 403 that the at least one other electronic device is not detected, the electronic device 100 returns to step 403 and again performs the subsequent steps. Alternatively, if it is determined in step 403 that the at least one other electronic device is detected, the electronic device 100 proceeds to step 405 and determines if a distance between the electronic device 100 and the detected at least one other electronic device is equal to or is less than a first threshold distance. In an embodiment, the first threshold distance can be preset in a design stage or can be configured by a user. At this time, the distance between the electronic device 100 and the detected at least one other electronic device can be measured using the motion sensor 140 and the communication unit 142.

If it is determined in step 405 that the distance between the electronic device 100 and the detected at least one other electronic device is greater than the first threshold distance, the electronic device 100 returns to step 405 and again performs the subsequent steps. Alternatively, if it is determined in step 405 that the distance between the electronic device 100 and the detected at least one other electronic device is equal to or is less than the first threshold distance, the electronic device 100 proceeds to step 407 and receives related information from the detected at least one other electronic device. Here, the related information includes one of model information of the detected at least one other electronic device, size information of a display of the detected at least one other electronic device, and resolution information of the display device of the detected at least one other electronic device.

After that, the electronic device 100 proceeds to step 409 and transmits an image to be displayed and split information to the detected at least one other electronic device. Here, the split information is one required for the electronic device 100 and the detected at least one other electronic device to operate in a split mode and display different portions of the same image. The split information can include information about a region to be displayed in each electronic device among the whole region of an original image, zoom-in information by mode, and information about a region to display an image among the whole region of a display of each electronic device. At this time, the split information can be generated in each electronic device, instead of being transmitted according to a design scheme of the electronic device 100 and a user control.

Next, the electronic device 100 proceeds to step 411 and determines if the distance between the electronic device 100 and the detected at least one other electronic device is equal to or is less than a second threshold distance. If it is determined in step 411 that the distance between the electronic device 100 and the detected at least one other electronic device is greater than the second threshold distance, the electronic device 100 returns to step 411 and again performs the subsequent steps. Alternatively, if it is determined in step 411 that the distance between the electronic device 100 and the detected at least one other electronic device is equal to or is less than the second threshold distance, the electronic device 100 proceeds to step 413 and displays the split image according to the received related information and the number of detected at least one other electronic device. That is, the electronic device 100 displays the split image on the basis of the split information that is generated according to the received related information and the number of detected at least one other electronic device. At this time, the electronic device 100 can real-timely transmit an image to be displayed in the electronic device 100 while the distance between the electronic device 100 and the detected at least one other electronic device is equal to or is less than the first threshold distance.

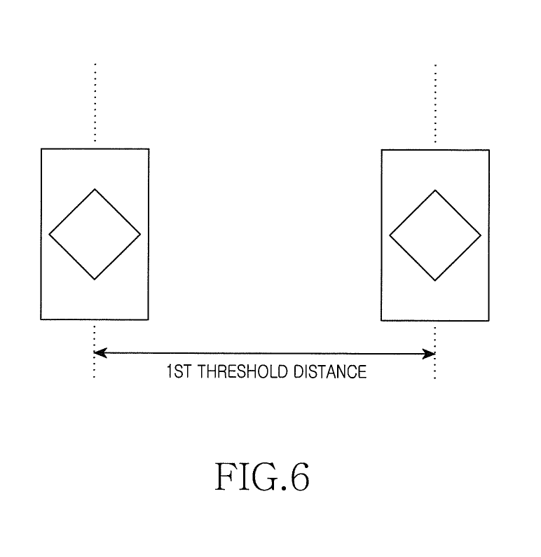

Next, the electronic device 100 proceeds to step 415 and determines if the distance between the electronic device 100 and the detected at least one other electronic device is greater than the second threshold distance. If it is determined in step 415 that the distance between the electronic device 100 and the detected at least one other electronic device is equal to or is less than the second threshold distance, the electronic device 100 returns to step 415 and again performs the subsequent steps. Alternatively, if it is determined in step 415 that the distance between the electronic device 100 and the detected at least one other electronic device is greater than the second threshold distance, the electronic device 100 proceeds to step 417 and displays the image in an initial state. In other words, if the distance between the electronic device 100 and the detected at least one other electronic device is increased greater than the second threshold distance when the electronic device 100 is displaying the split image according to the split information, the electronic device 100 and the detected at least one other electronic device operate in a sharing mode and each display the image independently without image splitting, as illustrated in FIG. 6.

After that, in step 419, the electronic device 100 determines if the distance between the electronic device 100 and the detected at least one other electronic device is greater than the first threshold distance. If it is determined in step 419 that the distance between the electronic device 100 and the detected at least one other electronic device is equal to or is less than the first threshold distance, the electronic device 100 returns to step 419 and again performs the subsequent steps. Alternatively, if it is determined in step 419 that the distance between the electronic device 100 and the detected at least one other electronic device is greater than the first threshold distance, the electronic device 100 terminates the procedure according to the present disclosure.

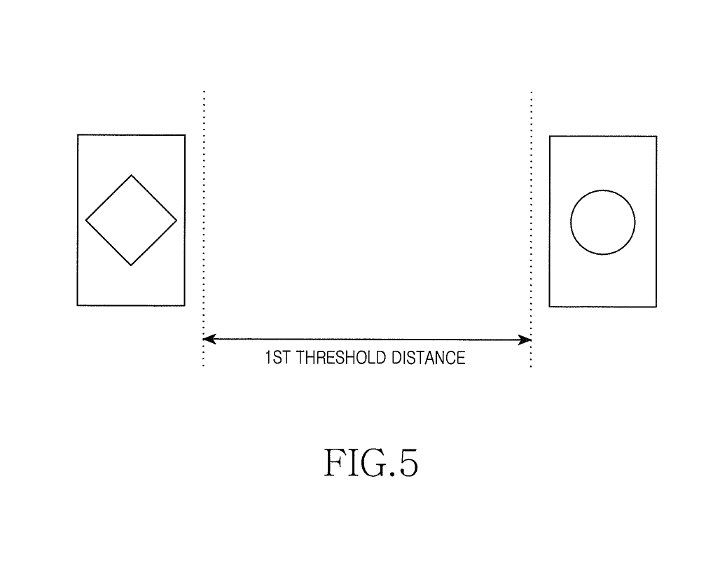

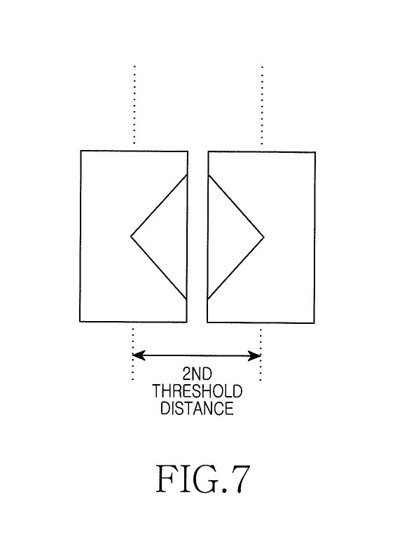

For instance, if the distance between the electronic device 100 and the detected at least one other electronic device is greater than the first threshold distance as illustrated in FIG. 5, the electronic device 100 and the detected at least one other electronic device operate separately and display different images. Next, if the distance between the electronic device 100 and the detected at least one other electronic device is equal to or is less than the first threshold distance as illustrated in FIG. 6, the electronic device 100 transmits the image of the electronic device 100 and split information thereof to the detected at least one other electronic device, so the electronic device 100 and the detected at least one other electronic device display the same image. Further, if the distance between the electronic device 100 and the detected at least one other electronic device is equal to or is less than the second threshold distance as illustrated in FIG. 7, the electronic device 100 and the detected at least one other electronic device display different regions of the same image on the basis of the split information and can obtain an effect in which two electronic devices display one image in cooperation with each other. According to this, the electronic device 100 and the detected at least one other electronic device can provide the image through a screen of a size larger than that of a screen of the electronic device 100.

FIG. 4B illustrates a procedure of sharing an image with other electronic device with a display of a different size and displaying the shared image in an electronic device according to another embodiment of the present disclosure. Here, the following description is made assuming a state in which the electronic device 100 has already performed steps 401 to 405 of FIG. 4A.

Referring to FIG. 4B, in step 407, the electronic device 100 receives related information from detected at least one other electronic device and then, proceeds to step 421 and determines size information of a display of the detected at least one other electronic device on the basis of the received related information. At this time, in a case where the received related information includes model information of the detected at least one other electronic device, the electronic device 100 can determine the display device size information of the detected at least one other electronic device by means of previously stored display device size information by electronic device model. Next, the electronic device 100 proceed to step 423 and determines if a display device size of the electronic device 100 is equal to or is greater than a display device size of the detected at least one other electronic device.

If it is determined in step 423 that the display device size of the electronic device 100 is equal to or is greater than the display device size of the detected at least one other electronic device, the electronic device 100 proceeds to step 425 and distinguishes a display region of the electronic device 100 into a split image display region 441 and an additional region 443 as illustrated in FIG. 4C. Next, the electronic device 100 determines an application to be executed in the additional region 443 of the electronic device 100. In an exemplary embodiment, the application to be executed in the additional region 443 of the electronic device 100 includes all applications executable in the electronic device 100. Next, the electronic device 100 proceeds to step 431 and transmits an image to be displayed and split information to the detected at least one other electronic device and then, proceeds to step 433 and determines if a distance between the electronic device 100 and the detected at least one other electronic device is equal to or is less than a second threshold distance. If the distance between the electronic device 100 and the detected at least one other electronic device is greater than the second threshold distance, the electronic device 100 returns to step 433 and again performs the subsequent steps. Alternatively, if the distance between the electronic device 100 and the detected at least one other electronic device is equal to or is less than the second threshold distance, the electronic device 100 proceeds to step 435 and displays the split image that is split according to the received related information and the number of detected at least one other electronic device and split information thereof, and executes the determined application in the additional region 443 of the electronic device 100. Next, the electronic device 100 proceeds to step 415 of FIG. 4A and performs the subsequent steps. At this time, the electronic device 100 displays the image in the split image display region 441.

Alternatively, if it is determined in step 423 that the display device size of the electronic device 100 is less than the display device size of the detected at least one other electronic device, the electronic device 100 proceeds to step 427 and distinguishes a display region of the detected at least one other electronic device into a split image display region 445 and an additional region 447 as illustrated in FIG. 4D. Next, the electronic device 100 determines an application to be executed in the additional region 447 of the detected at least one other electronic device. In an exemplary embodiment, the application to be executed in the additional region 447 of the detected at least one other electronic device includes all applications executable in the detected at least one other electronic device. After that, the electronic device 100 proceeds to step 431 and transmits an image to be displayed and split information to the detected at least one other electronic device. Next, in step 433, the electronic device 100 determines if the distance between the electronic device 100 and the detected at least one other electronic device is equal to or is less than the second threshold distance. At this time, upon transmission of the image to be displayed and the split information, the electronic device 100 additionally transmits application information to be executed in the additional region 447 of the detected at least one other electronic device to the detected at least one other electronic device. In an exemplary embodiment, the split information includes information about the image display region 445 and the additional region 447. According to this, the detected at least one other electronic device executes the application according to the application information to be executed in the additional region 447 of the detected at least one other electronic device, and displays the executed application.

If it is determined in step 433 that the distance between the electronic device 100 and the detected at least one other electronic device is greater than the second threshold distance, the electronic device 100 returns to step 433 and again performs the subsequent steps. Alternatively, if it is determined in step 433 that the distance between the electronic device 100 and the detected at least one other electronic device is equal to or is less than the second threshold distance, the electronic device 100 proceeds to step 435 and displays the split image according to the received related information and the number of detected at least one other electronic device. And then, the electronic device 100 proceeds to step 415 of FIG. 4A and performs the subsequent steps.

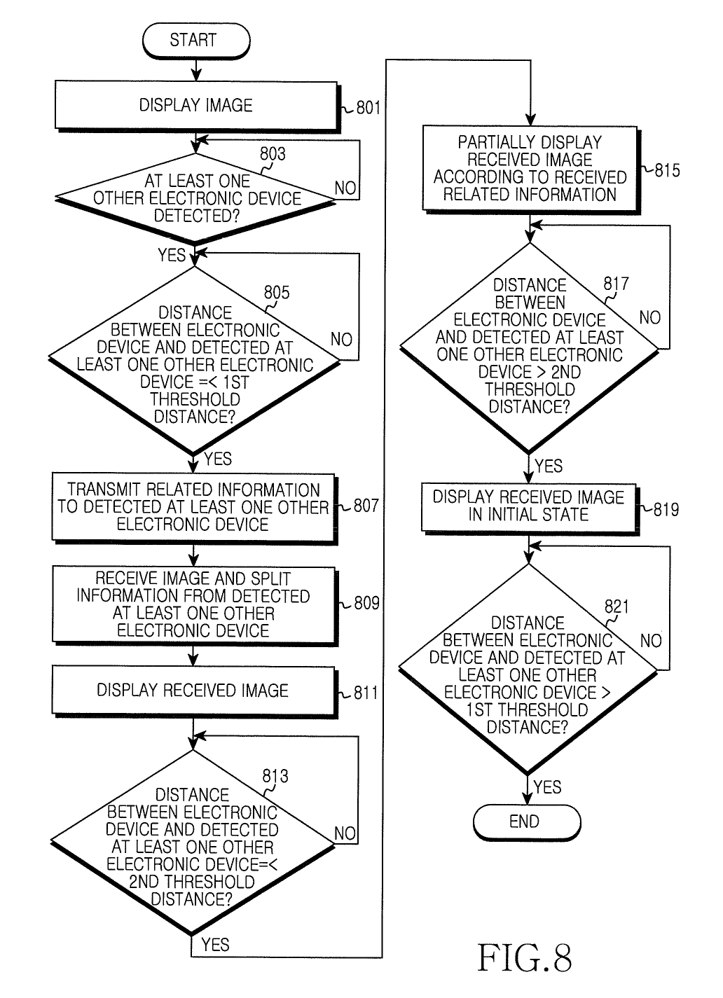

FIG. 8 illustrates a procedure of receiving a shared image from detected other electronic devices and displaying the shared image in an electronic device 100 according to a further exemplary embodiment of the present disclosure.

Referring to FIG. 8, in step 801, the electronic device 100 displays an image. Here, the image refers to an image including all graphic elements (e.g., an icon, a UI, an image and the like) displayed in a display device of the electronic device 100. Next, in step 803, the electronic device 100 determines if at least one other electronic device is detected. At this time, the electronic device 100 can detect the at least one other electronic device through at least one of a plurality of sensors such as NFC, a motion sensor, IrDA and the like and wireless communication, and can determine a distance to the detected at least one other electronic device and the direction or location of the detected at least one other electronic device.

If it is determined in step 803 that the at least one other electronic device is not detected, the electronic device 100 returns to step 803 and again performs the subsequent steps. Alternatively, if it is determined in step 803 that the at least one other electronic device is detected, the electronic device 100 proceeds to step 805 and determines if a distance between the electronic device 100 and the detected at least one other electronic device is equal to or is less than a first threshold distance. In an exemplary embodiment, the first threshold distance can be preset in a design stage or can be configured by a user. If it is determined in step 805 that the distance between the electronic device 100 and the detected at least one other electronic device is greater than the first threshold distance, the electronic device 100 returns to step 805 and again performs the subsequent steps. Alternatively, if it is determined in step 805 that the distance between the electronic device 100 and the detected at least one other electronic device is equal to or is less than the first threshold distance, the electronic device 100 proceeds to step 807 and transmits related information to the detected at least one other electronic device. Here, the related information includes one of model information of the electronic device 100, size information of a display device of the electronic device 100, and resolution information of the display device of the electronic device 100.

After that, the electronic device 100 proceeds to step 809 and receives an image and split information from the detected at least one other electronic device. The split information can include information about a region to be displayed in each electronic device among the whole region of an original image, zoom-in information by mode, and information about a region to display an image among the whole region of a display device of each electronic device.

Next, the electronic device 100 proceeds to step 811 and displays the received image. For instance, if the received image is a video image of the detected at least one other electronic device, the electronic device 100 can receive the video image and then display the received video image. At this time, the electronic device 100 can real-timely receive the video image from the detected at least one other electronic device and, as if a video application is run in the electronic device 100, the electronic device 100 can display the received video image.

After that, in step 813, the electronic device 100 determines if the distance between the electronic device 100 and the detected at least one other electronic device is equal to or is less than a second threshold distance. If it is determined in step 813 that the distance between the electronic device 100 and the detected at least one other electronic device is greater than the second threshold distance, the electronic device 100 returns to step 813 and again performs the subsequent steps. Alternatively, if it is determined in step 813 that the distance between the electronic device 100 and the detected at least one other electronic device is equal to or is less than the second threshold distance, the electronic device 100 proceeds to step 815 and displays the received image according to the received related information. That is, the electronic device 100 can split the received image according to the split information received from the detected at least one other electronic device and then zoom in and display the split image, or can determine a region to be displayed among, the received image according to the split information and then zoom in and display only the determined region.

Next, the electronic device 100 proceeds to step 817 and determines if the distance between the electronic device 100 and the detected at least one other electronic device is greater than the second threshold distance. If it is determined in step 817 that the distance between the electronic device 100 and the detected at least one other electronic device is equal to or is less than the second threshold distance, the electronic device 100 returns to step 817 and again performs the subsequent steps. Alternatively, if it is determined in step 817 that the distance between the electronic device 100 and the detected at least one other electronic device is greater than the second threshold distance, the electronic device 100 proceeds to step 819 and displays the received image of the detected at least one other electronic device in an initial state. In other words, if the distance between the electronic device 100 and the detected at least one other electronic device is increased greater than the second threshold distance when the electronic device 100 is displaying the split image, the electronic device 100 and the detected at least one other electronic device each display an image independently without image splitting, as illustrated in FIG. 6.

After that, in step 821, the electronic device 100 determines if the distance between the electronic device 100 and the detected at least one other electronic device is greater than the first threshold distance. If it is determined in step 821 that the distance between the electronic device 100 and the detected at least one other electronic device is equal to or is less than the first threshold distance, the electronic device 100 returns to step 821 and again performs the subsequent steps. Alternatively, if it is determined in step 821 that the distance between the electronic device 100 and the detected at least one other electronic device is greater than the first threshold distance, the electronic device 100 terminates the procedure according to the present disclosure. At this time, if the distance between the electronic device 100 and the detected at least one other electronic device is greater than the first threshold distance, the electronic device 100 can display an image of the electronic device 100 before displaying the image of the detected at least one other electronic device.

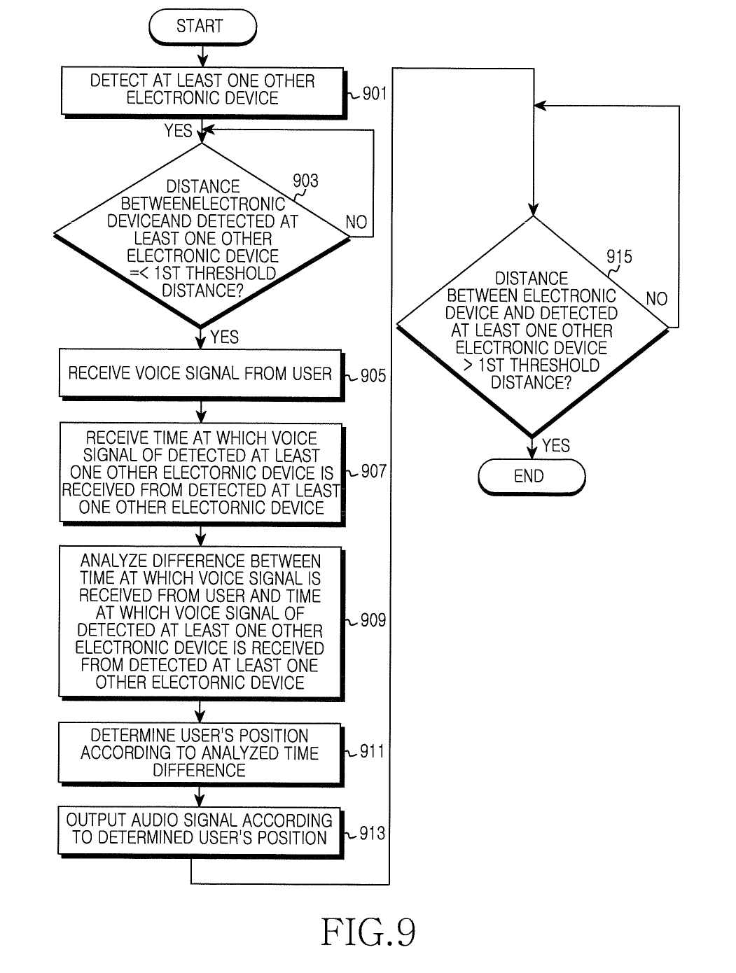

FIG. 9 illustrates a procedure of outputting an audio signal based on a user's position in an electronic device 100 according to a further exemplary embodiment of the present disclosure.

Referring to FIG. 9, in step 901, the electronic device 100 detects at least one other electronic device. At this time, the electronic device 100 can detect the at least one other electronic device through at least one of a plurality of sensors such as NFC, a motion sensor, IrDA and the like and wireless communication, and can determine a distance to the detected at least one other electronic device and the direction or location of the detected at least one other electronic device.

After that, the electronic device 100 proceeds to step 903 and determines if a distance between the electronic device 100 and the detected at least one other electronic device is equal to or is less than a first threshold distance. If it is determined in step 903 that the distance between the electronic device 100 and the detected at least one other electronic device is greater than the first threshold distance, the electronic device 100 returns to step 901 and again performs the subsequent steps. Alternatively, if it is determined in step 903 that the distance between the electronic device 100 and the detected at least one other electronic device is equal to or is less than the first threshold distance, the electronic device 100 proceeds to step 905 and receives a voice signal from a user. At this time, the electronic device 100 can receive the voice signal from the user through the microphone 148. If other electronic device located in the first threshold distance or less is detected, the electronic device 100 can activate the microphone 148 automatically or by user control.

Next, the electronic device 100 proceeds to step 907 and receives a time at which a audio signal of the detected at least one other electronic device is received from the detected at least one other electronic device and then, proceeds to step 909 and analyzes a difference between a time at which the voice signal is received from the user and the time at which the voice signal of the detected at least one other electronic device is received from the detected at least one other electronic device. Next, the electronic de vice 100 proceeds to step 911 and determines a user's position according to the analyzed time difference. In detail, the electronic device 100 can analyze the time at which the audio signal reaches the electronic device 100 and the time at which the audio signal reaches the at least one other electronic device, analyze the distance between the electronic device 100 and the detected at least one other electronic device, and determine the user's position. At this time, the voice signal that the electronic device 100 receives from the user and the audio signal that the at least one other electronic device receives are audio signals generated at the same time point from the same user. If voice signals are received from a plurality of users, the electronic device 100 can analyze a difference of time at which the voice signals are received by user.

After that, the electronic device 100 proceeds to step 913 and outputs an audio signal having specific directivity according to the determined user's position. At this time, to provide a stereoscopic sound and surround system according to the determined at least one user's position, the electronic device 100 can separate an audio channel, generate a sound filter having directivity according to the number of users and a position by user, and output an audio signal through the generated sound filter. Also, the sound filter can be applied in real-timely, or a filter determined previously according to a user position can be applied according to the user position.

Next, the electronic device 100 proceeds to step 915 and determines if the distance between the electronic device 100 and the detected at least one other electronic device is greater than the first threshold distance. If it is determined in step 915 that the distance between the electronic device 100 and the detected at least one other electronic device is equal to or is less than the first threshold distance, the electronic device 100 returns to step 915 and again performs the subsequent steps. Alternatively, if it is determined in step 915 that the distance between the electronic device 100 and the detected at least one other electronic device is greater than the first threshold distance, the electronic device 100 terminates the procedure according to the present disclosure.

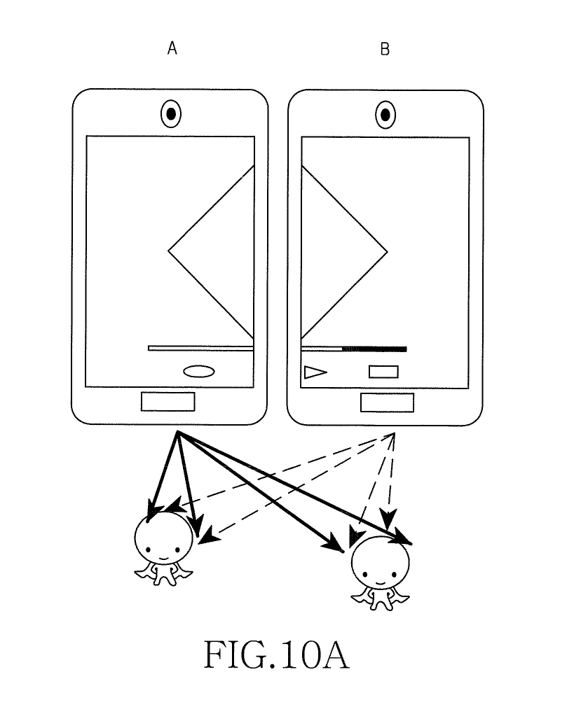

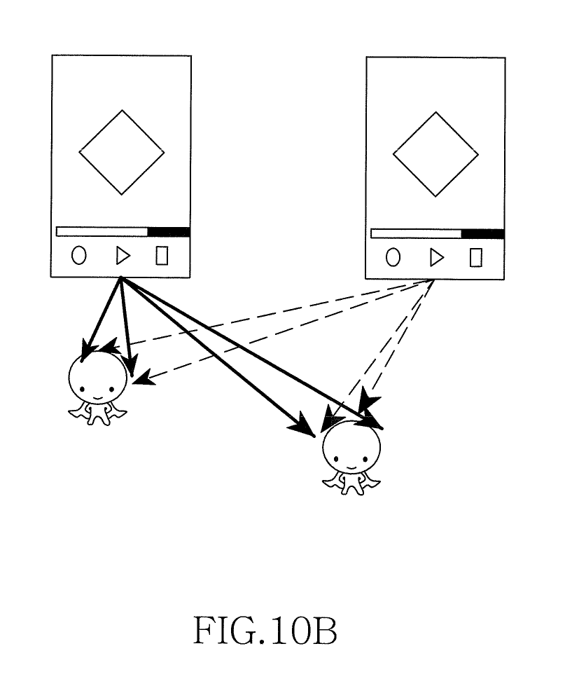

For example, if the electronic device 100 and the detected at least one other electronic device are located within a second threshold distance and thus the electronic device 100 operates in a split mode as illustrated in FIG. 10A, the electronic device 100 and the detected at least one other electronic device each estimate a position of each of two users and provide an audio signal on the basis of a sound filter having directivity corresponding to the position of each user. Further, even when the electronic device 100 and the detected at least one other electronic device are located between the first threshold distance and the second threshold distance and thus the electronic device 100 operates in a sharing mode as illustrated in FIG. 10B, the electronic device 100 and the detected at least one other electronic device each estimate a position of each of two users and provide an audio signal on the basis of a sound filter having directivity corresponding to the position of each user.

The aforementioned description has been made in which the electronic device 100 estimates a user position by using a user voice signal inputted from the microphone 148, but the electronic device 100 can analyze an image inputted from the camera 144, estimate a user position, and output an audio signal having directivity corresponding to a position of each user by using a sound filter according to the position of each user.

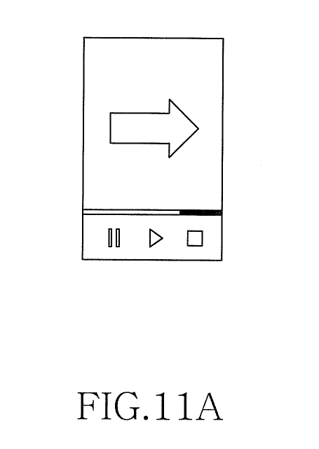

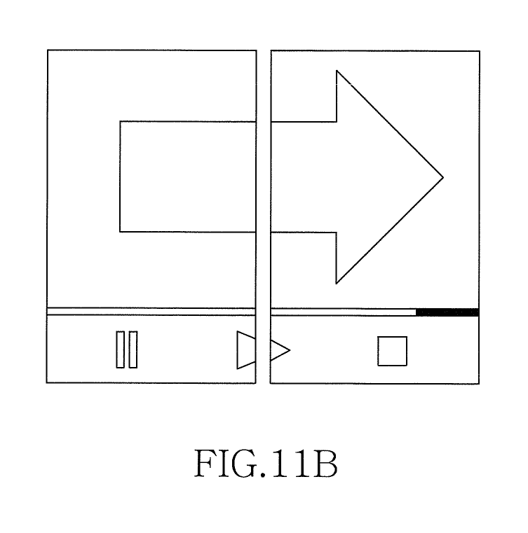

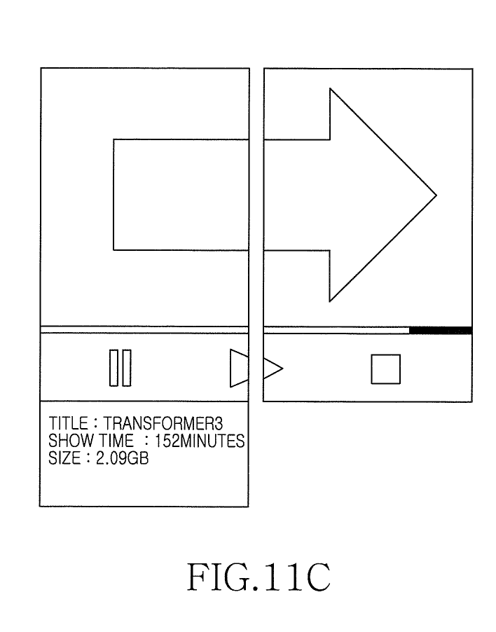

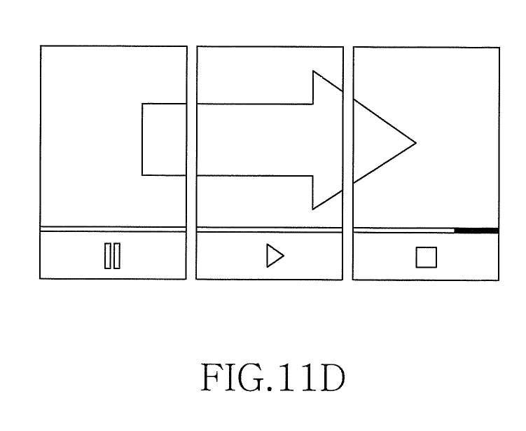

FIGS. 11A to 11D illustrate examples of transmitting an image including a video UI to detected other electronic device and displaying the image on an electronic device 100 according to a further exemplary embodiment of the present disclosure.

When the electronic device 100 is executing a video application as illustrated in FIG. 11A, the electronic device 100 can detect other electronic devices in the peripheral. After that, if a distance to the detected other electronic device becomes a second threshold distance or less, the electronic device 100 can transmit a video image of the electronic device 100 and split information thereof to the detected other electronic device. At this time, the electronic device 100 can transmit a UI image for controlling video execution in addition to the video image and the split information. According to this, as illustrated in FIG. 11B, the electronic device 100 and the detected other electronic device can concurrently display the video image and the UI image for controlling the video execution. At this time, if a touch on the UI image is sensed in the detected other electronic device, the detected other electronic device can transmit a coordinate of the touch-sensed UI image to the electronic device 100, and the electronic device 100 receiving the coordinate of the UI image can perform a video execution control function (e.g., pause, play, stop, fast forward, reverse and the like) corresponding to the received coordinate of the UI image, and transmit an image showing the performing result to the detected other electronic device.

If a display device size of the electronic device 100 is larger than a display device size of the detected other electronic device, the electronic device 100 can execute other application in an additional region of the electronic device 100 as illustrated in FIG. 11C.

Also, even when two or more other electronic devices are detected, the electronic device 100 and the detected two or more other electronic devices can concurrently display an image and a UI image as illustrated in FIG. 11D.

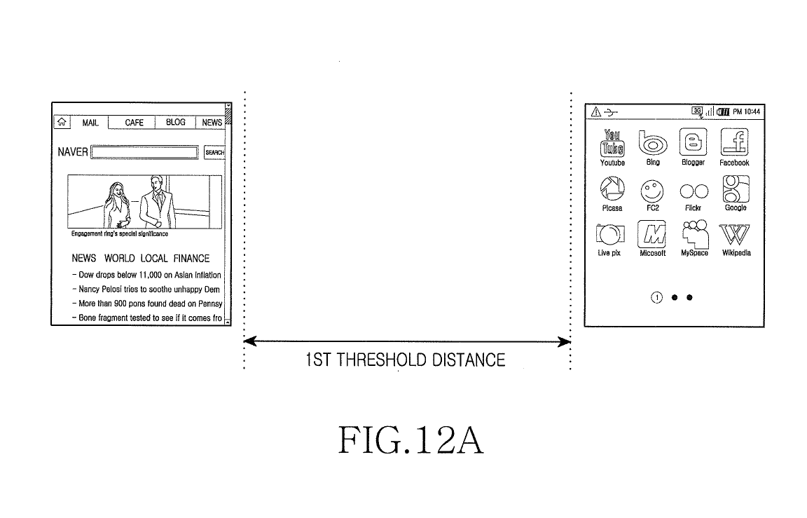

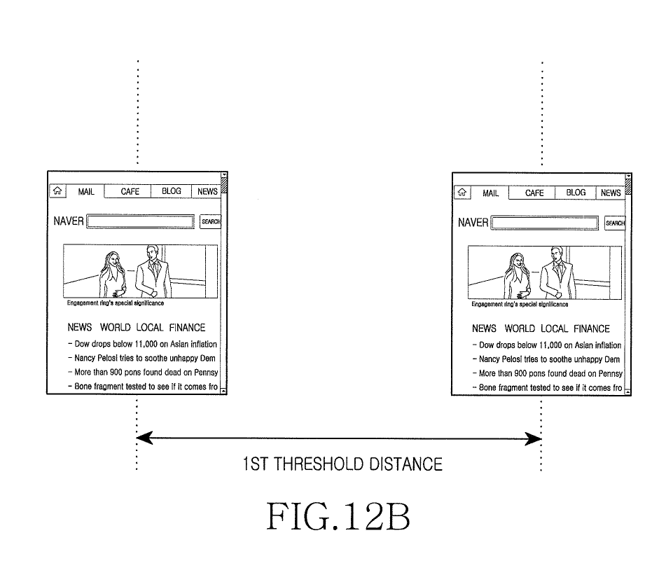

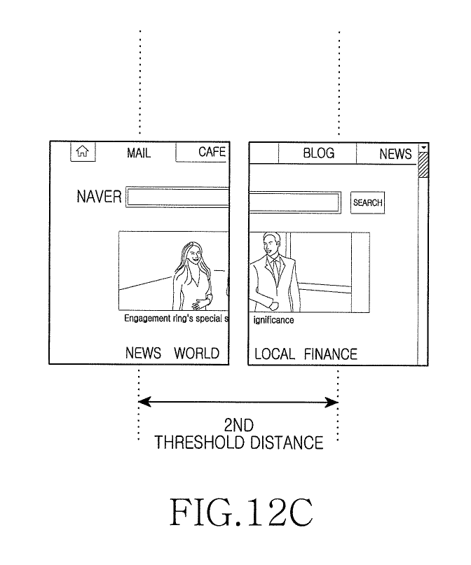

FIGS. 12A to 12C illustrate examples of sharing an Internet image according to a distance between electronic devices and displaying the shared image on a plurality of electronic devices according to a further exemplary embodiment of the present disclosure.

If a distance between the electronic device 100 and detected other electronic device is greater than a first threshold distance as illustrated in FIG. 12A, the electronic device 100 displays an Internet image, and the detected other electronic device displays a waiting screen (or a home screen). After that, if the distance between the electronic device 100 and the detected other electronic device is equal to or is less than the first threshold distance as illustrated in FIG. 12B, the electronic device 100 transmits the Internet image of the electronic device 100 and split information thereof to the detected other electronic device, so the electronic device 100 and the detected other electronic device display the same Internet image. Further, if the distance between the electronic device 100 and the detected other electronic device is equal to or is less than a second threshold distance as illustrated in FIG. 12C, the electronic device 100 displays an image of a left region of the Internet image according to the split information, and the detected other electronic device displays an image of a right region of the split Internet image.

According to this, the electronic device 100 can display an zoomed image in comparison to the initially displayed image of the electronic device 100, through the electronic device 100 and the detected other electronic device.

FIGS. 13A and 13B illustrate examples of determining a shared image display region in a plurality of non-aligned electronic devices according to a further exemplary embodiment of the present disclosure. For description convenience, the following description is made by way of example assuming that one electronic device is detected. But, the present disclosure is applicable in the same scheme even when a plurality of electronic devices are detected.

Referring to FIGS. 13A and 13B, if an electronic device 100 and a detected other electronic device are located within a second threshold distance, the electronic device 100 and the detected other electronic device can display guide lines 1301 and 1303 for adjusting positions of displayed images, respectively. The guide line 1301 displayed in the electronic device 100 and the guide line 1303 displayed in the detected other electronic device can be displayed in different positions or the same position. Although the electronic device 100 and the detected other electronic device display the guide lines 1301 and 1303 in the same position, if the electronic device 100 and the detected other electronic device are not aligned in line and are located out of line as illustrated in FIG. 3A, even the guide lines 1301 and 1303 are displayed out of line in the electronic device 100 and the detected other electronic device.

Next, the electronic device 100 and the detected other electronic device can detect a user touch for moving positions of the displayed guide lines 1301 and 1303 and, according to the user touch, move a position of at least one of the guide lines 1301 and 1303 displayed in the two electronic devices. In other words, to synchronize a shared image to be displayed through the two electronic devices, a user can move the position of at least one of the guide lines 1301 and 1303 in order to align in line the guide lines 1301 and 1303 of the two electronic devices. FIG. 3A illustrates a case where a user touches and drags down the guide line 1303 of the detected other electronic device as denoted by reference numeral 1305. At this time, the two electronic devices can exchange coordinate information at which the guide lines 1301 and 1303 are located.

According to this, on the basis of the positions of the guide lines 1301 and 1305 changed according to the user touch, the electronic device 100 and the detected other electronic device determine a region to display an image among the whole region of a display device of each electronic device and a region to be displayed in each electronic device among the whole region of an original image, whereby the shared image can be aligned in line and displayed in the two electronic devices. For example, as illustrated in FIG. 13B, the electronic device 100 can display the shared image on the whole region of the display device of the electronic device 100, and the detected other electronic device can display the shared image on a partial region among the whole region of the display device of the detected other electronic device. At this time, the detected other electronic device can determine as an additional region a region where the shared image is not displayed and display other application execution image on the additional region.

The aforementioned description has been made for a scheme of receiving an image from at least one of the electronic device 100 and detected other electronic device and then displaying the received image. But, this does not intend to limit the scope and spirit of the present disclosure and the present disclosure can use a scheme in which the electronic device 100 and the detected other electronic device receive an image from a server providing a specific image and display the received image.

The aforementioned description has been made for a method in which the electronic device 100 and detected other electronic device transmit and receive an image and a coordinate of data inputted to the image, whereby the electronic device 100 and the detected other electronic device display the image resulting from the inputted data. But, this does not intend to limit the scope and spirit of the present disclosure and the present disclosure can perform a method in which, when detected other electronic device has an application corresponding, to an image, the electronic device 100 transmits contents corresponding to the image and a contents execution instruction to the detected other electronic device, and the detected other electronic device executes the received content. For example, when the electronic device 100 is displaying a video image, if other electronic device having a video application is detected, if the electronic device 100 transmits video content and a video application execution instruction to the detected other electronic device, the detected other electronic device can display the whole or part of a video image and UI image resulting from the execution of the corresponding video content, according to a sharing mode or a split mode.

Exemplary embodiments of the disclosure described in this specification and all function operations thereof can be implemented by computer software including a structure disclosed in this specification and equivalent structures thereof, firmware, hardware, or one or more combinations of them. Also, the exemplary embodiments of the disclosure described in this specification are implemented by one or more computer program products, i.e., data processing devices or can be implemented by one or more modules of encoded computer program instructions on a computer-readable medium for controlling operations of the data processing devices.

The computer-readable medium can be a machine-readable storage medium, a machine-readable storage substrate, a memory device, a construction of material affecting a machine-readable propagation stream, or one or more combinations of them. The term of data processing device includes, for example, a programmable processor, a computer, a multiple processor, or all data processing equipments, devices, and machines including the computer. The equipment can include a code added to hardware and generating an execution environment for a corresponding computer program, for instance, a code constructing a processor firmware, a protocol stack, a database management system, an operating system, or one or more combinations of them.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A method for displaying an image on an electronic device, the method comprising:
displaying an image on the electronic device;
detecting presence of at least one other electronic device;
if the electronic device and the detected at least one other electronic device are located within a first threshold distance, transmitting the image and display control information to the at least one other electronic device to display the image on the at least one other electronic device; and
if the electronic device and the detected at least one other electronic device are located within a second threshold distance, transmitting the image and the display control information to the at least one other electronic device to display a split image on the basis of a number of detected at least one other electronic device on the at least one other electronic device.

2. The method of claim 1, further comprising:
acquiring information on at least one of a model, a display size, a resolution, a location, and the number of the detected at least one other electronic device; and
generating the display control information on the basis of the acquired information by:
comparing a display size of the electronic device with a display size of the detected at least one other electronic device; and
distinguishing a region of a display device of a larger size into an image display region and an additional region, the additional region displaying an image resulting from separate application execution, and
wherein the display control information comprises information on at least one of a region to be displayed in each electronic device among the whole region of an original image, zoom-in, and a region to display an image among the whole region of a display device of each electronic device.

3. The method of claim 2, wherein generating the display control information comprises:
displaying a guide line in the electronic device for alignment of images to be displayed in the electronic device and the detected at least one other electronic device;
receiving a coordinate corresponding to a guide line from the detected at least one other electronic device; and
generating the display control information on the basis of a coordinate at which the guide line of the electronic device is displayed and the coordinate received from the detected other electronic device.

4. The method of claim 1, further comprising:
receiving a voice signal from at least one user;
receiving time information at which the voice signal is received by and from the detected at least one other electronic device;
analyzing a difference between a time at which the voice signal is received by the electronic device and a time at which the voice signal is received by the detected at least one other electronic device;
determining a position of the at least one user on the basis of the time difference; and
outputting an audio signal by using a sound filter corresponding to the determined position by user.

5. The method of claim 1, further comprising:
capturing an image of at least one user by using a camera;
determining a position of the at least one user on the basis of the captured image; and
outputting an audio signal by using a sound filter corresponding to the determined position by user.

6. The method of claim 1, further comprising:
receiving a coordinate of an image from the detected at least one other electronic device;
executing a function of a user interface corresponding to the coordinate of the image;
transmitting an image corresponding to the execution result, to the detected at least one other electronic device; and
displaying the image corresponding to the execution result in the electronic device.

7. A method for displaying an image on an electronic device, the method comprising:
detecting at least one other electronic device;
if the electronic device and the detected at least one other electronic device are located within a first threshold distance, receiving an image and display control information from the detected at least one other electronic device;
displaying the received image; and
if the electronic device and the detected at least one other electronic device are located within a second threshold distance, displaying a split image on the basis of the display control information,
wherein the display control information comprises information on at least one of a region to be displayed in each electronic device among the whole region of an original image and zoom-in, and a region to display an image among the whole region of a display device of each electronic device.

8. The method of claim 7, further comprising:
if the electronic device and the detected at least one other electronic device are located within the first threshold distance, transmitting information on at least one of a model, display size, a resolution and a location of the detected at least one other electronic device.

9. The method of claim 7, further comprising:
displaying, a guide line in the electronic device for aligning images to be displayed on the electronic device and the detected at least one other electronic device;
determining a coordinate of the guide line according to a user control; and
transmitting the determined coordinate of the guide line to the detected at least one other electronic device.

10. The method of claim 7, further comprising:
receiving an audio signal from at least one user;
transmitting a time at which the audio signal is received by the electronic device, to the detected at least one other electronic device;
receiving sound filter information corresponding to a position of the at least one user from the detected at least one other electronic device; and
outputting an audio signal by using the received sound filter information.

11. The method of claim 7, further comprising:
capturing an image of at least one user by using a camera;
transmitting the captured image to the detected at least one other electronic device;
receiving sound filter information corresponding to a position of the at least one user from the detected at least one other electronic device; and
outputting an audio signal by using the received sound filter information.

12. The method of claim 7, further comprising:
while displaying the received image, detecting a user touch; and
transmitting a coordinate of an image corresponding to the detected user touch, to the detected at least one other electronic device.

13. An electronic device for displaying an image, comprising:
a display device configured to present information;
a memory configured to storing data and instructions; and
one or more programs stored in the memory and configured to be executed by one or more processors,
wherein the program comprises an instruction set for displaying an image, detecting at least one other electronic device and if the electronic device and the detected at least one other electronic device are located within a first threshold distance, transmitting the image and display control information to the at least one other electronic device to display the image on the at least one other electronic device and if the electronic device and the detected at least one other electronic device are located within a second threshold distance, transmitting the image and display control information to the at least one other electronic device to display a split image on the basis of the number of detected at least one other electronic device.

14. The electronic device of claim 13, wherein the program comprises an instruction set for acquiring information on at least one of a model, display size, a resolution, a location, and a number of the detected at least one other electronic device, generating the display control information on the basis of the acquired information, comparing a display size of the electronic device to a display size of the detected at least one other electronic device, distinguishing a region of a display device of a larger size into an image display region and an additional region, and displaying an image on the image display region and the additional region, and
wherein the display control information comprises information on at least one of a region to be displayed in each electronic device among the whole region of an original image, zoom-in, and a region to display an image among, the whole region of a display device of each electronic device.

15. The electronic device of claim 13, wherein the program further comprises an instruction set for displaying a guide line in the display device of the electronic device for aligning images to be displayed on the electronic device and the detected at least one other electronic device, receiving a coordinate corresponding to a guide line from the detected at least one other electronic device, and generating the display control information on the basis of a coordinate at which the guide line of the electronic device is displayed and the coordinate received from the detected other electronic device.

16. The electronic device of claim 13, further comprising:
a microphone configured to receive an audio signal from at least one user; and
a speaker configured to output an audio signal,
wherein the program further comprises an instruction set for receiving, time information at which the voice signal is received by the detected at least one other electronic device from the detected at least one other electronic device, analyzing a difference between a time at which the voice signal is received by the electronic device and a time at which the voice signal is received by the detected at least one other electronic device, determining a position of the at least one user on the basis of the time difference, and outputting an audio signal by using a sound filter corresponding to the determined position by user.

17. The electronic device of claim 13, further comprising:
a camera configured to capture an image of at least one user; and
a speaker configured to output an audio signal,
wherein the program further comprises an instruction set for determining a position of the at least one user on the basis of the captured image, and outputting an audio signal by using a sound filter corresponding to the determined position by user.

18. The electronic device of claim 13, wherein the program further comprises an instruction set for receiving a coordinate of an image from the detected at least one other electronic device, executing a function of a user interface corresponding to the coordinate of the image, transmitting an image corresponding to the execution result to the detected at least one other electronic device, and displaying the image corresponding to the execution result in the electronic device.

19. An electronic device for displaying an image, comprising:
a display device configured to present information;
a memory configured to store data and instructions; and
one or more programs stored in the memory and configured to be executed by one or more processors,
wherein the program comprises an instruction set for detecting at least one other electronic device and, if the electronic device and the detected at least one other electronic device are located within a first threshold distance, receiving an image and display control information from the detected at least one other electronic device, displaying the received image and, if the electronic device and the detected at least one other electronic device are located within a second threshold distance, displaying a split image on the basis of the display control information,
wherein the display control information comprises information on at least one of a region to be displayed in each electronic device among the :whole region of an original image, zoom-in, and a region to display an image among the whole region of a display device of each electronic device.

20. The electronic device of claim 19, wherein the program further comprises an instruction set for, if the electronic device and the detected at least one other electronic device are located within the first threshold distance, transmitting information on at least one of a model, a display size, a resolution, and a location of the detected at least one other electronic device.

21. The electronic device of claim 19, wherein the program further comprises an instruction set for displaying a guide line in the display device of the electronic device for aligning images to be displayed in the electronic device and the detected at least one other electronic device, determining a coordinate of the guide line according to a user control, and transmitting, the determined coordinate of the guide line to the detected at least one other electronic device.

22. The electronic device of claim 19, further comprising:
a microphone configured to receive a voice signal from at least one user; and
a speaker configured to output an audio signal,
wherein the program further comprises an instruction set for transmitting a time at which the voice signal is received by the electronic device to the detected at least one other electronic device, receiving sound filter information corresponding to a position of the at least one user from the detected at least one other electronic device, and outputting an audio signal by using the received sound filter information.

23. The electronic device of claim 19, wherein the display device is a touch sense display device, and
wherein the program further comprises an instruction set for, while displaying the received image, detecting a user touch, and transmitting a coordinate of an image corresponding to the detected user touch, to the detected at least one other electronic device.
